(19) United States
(12) Patent Application Publication
(10) Pub. No.: US 2012/0187701 A1
(43) Pub. Date: Jul. 26, 2012

(54) SEAL-LOCK WITH DESTRUCTION-IDENTIFYING STRUCTURE

(76) Inventor: WEN-HO TSAI, KAOHSIUNG CITY (TW)

(21) Appl. No.: 13/303,252

(22) Filed: Nov. 23, 2011

(30) Foreign Application Priority Data
Jan. 20, 2011 (TW) 100201307

(51) Int. Cl. E05C 1/08; E05B 63/00

(52) U.S. Cl. 292/137

(57) ABSTRACT

A seal-lock with destruction-identifying structure includes a body having an opening in communication with an interior of the body. The seal-lock further includes a bolt having a shank. The shank and the body are so configured that coupling of the shank and the body is easy but disengagement of the shank from the body after coupling of the shank and the body is difficult. The bolt includes a head on a top end of the shank. The head has a diameter larger than a diameter of the shank. A transparent protective cover is mounted around the head and the shank. The shank can include a tag or pattern formed on an outer periphery of the shank. The tag or pattern is selected from a group consisting of letters, figures, symbols, and numbers. The tag or pattern is exposed out of the body after the shank is coupled with the body.

### BACKGROUND OF THE INVENTION

The present invention relates to a seal-lock and, more particularly, to a seal-lock with destruction-identifying structure to allow identification of destruction of the seal-lock.

Locks are generally used on doors of cargo containers to prevent the valuable goods in the cargo containers from being stolen, switched or maliciously destroyed, avoiding the loss of property, transaction credit, and reputation of the cargo owners as well as judicial investigation which may be initiated if the goods are switched into dangerous or illegal products. Although the theft, switching, and destruction of the goods is not uncommon, actions, such as reporting to the police, proceeding with an investigation, immediately checking the goods, or notifying the goods receiver, can be taken if the theft, switching, and destruction of the goods can immediately be found. In this regard, a seal-type lock has been proposed in the door locks and includes a unique seal that will be damaged when opened. The user can check whether the lock is opened by checking the integrity of the seal lock. However, such a seal-type lock is troublesome and inconvenient in use.

To provide a simple option, a seal-lock 1 shown in FIG. 5 has been proposed. The seal-lock 1 includes a body 11 having an opening 111 in communication with an interior of the body 11. The seal-lock 1 further includes a bolt 12 having a shank 121. With reference to FIG. 6, the shank 121 and the body 11 are so configured that coupling of the shank 121 and the body 11 is easy but disengagement of the shank 121 from the body 11 after coupling of the shank 121 and the body 11 is difficult. A head 122 is formed on a top end of the bolt 121. The diameters of the head 122 and the body 11 are larger than the diameter of the shank 121. With reference to FIGS. 5 and 7, the bolt 12 is generally made of metal to provide desired structural strength. A protective cover 123A is provided around the shank 121 and the head 122 to avoid the exposed portion of the metal from rusting. Another protective cover 123B is provided around the body 11. The protective covers 123A and 123B are generally not transparent, such as blue.

Before insertion into the opening 111, the shank 121 is extended through holes in locking plates on doors (or on a door and a frame) of a cargo container. After the shank 121 is inserted into the opening 111, the head 122 and the body 11 form two stops at two ends preventing removal of the seal lock 1. In an example of the easy-to-couple/difficult-to-disengage arrangement shown in FIG. 6, the shank 121 includes an annular groove 123 in a section thereof. The interior of the body 11 includes a flange 112 corresponding to the annular groove 123. When the shank 121 is forcibly inserted into the interior of the body 11, the flange 112 is engaged in the annular groove 123, preventing disengagement of the shank 121.

With reference to FIGS. 4, 6, and 8, in the theft, switching, and destruction of the goods, it is common that an intruder cut a section of the shank 121 adjacent to the head 122 by a tool so as to remove the shank 121 from the holes of the locking plates. Since the protective cover 123A is also cut, the intruder generally prepares a protective cover 123C imitating the protective cover 123A. Since the protective covers 123A and 123C are not transparent, it is not easy to notice that the head 122 has been cut off after the seal-lock 1 is destroyed. As a result, immediate actions, such as such as reporting to the police, reporting to the police, proceeding with an investigation, immediately checking the goods, or notifying the goods receiver, can be taken.

### BRIEF SUMMARY OF THE INVENTION

A seal-lock with destruction-identifying structure according to the present invention includes a body having an opening in communication with an interior of the body. The seal-lock further includes a bolt having a shank. The shank and the body are so configured that coupling of the shank and the body is easy but disengagement of the shank from the body after coupling of the shank and the body is difficult. The bolt includes a head on a top end of the shank. The head has a diameter larger than a diameter of the shank. A transparent protective cover is mounted around the head and the shank.

In a form shown, the shank includes a tag or pattern formed on an outer periphery of the shank. The tag or pattern is selected from a group consisting of letters, figures, symbols, and numbers. The tag or pattern is exposed out of the body after the shank is coupled with the body.

The present invention will become clearer in light of the following detailed description of illustrative embodiments of this invention described in connection with the drawings.

### DESCRIPTION OF THE DRAWINGS

FIG. 1 shows an exploded, perspective view of a seal-lock according to the present invention.

FIG. 2 shows a cross sectional view of the seal-lock of FIG. 1.

FIG. 3 shows a perspective view of the seal-lock of FIG. 1.

FIG. 4 shows a perspective view of another example of the seal-lock according to the present invention.

FIG. 5 shows a perspective view of a conventional seal-lock, with protective covers removed form the seal-lock.

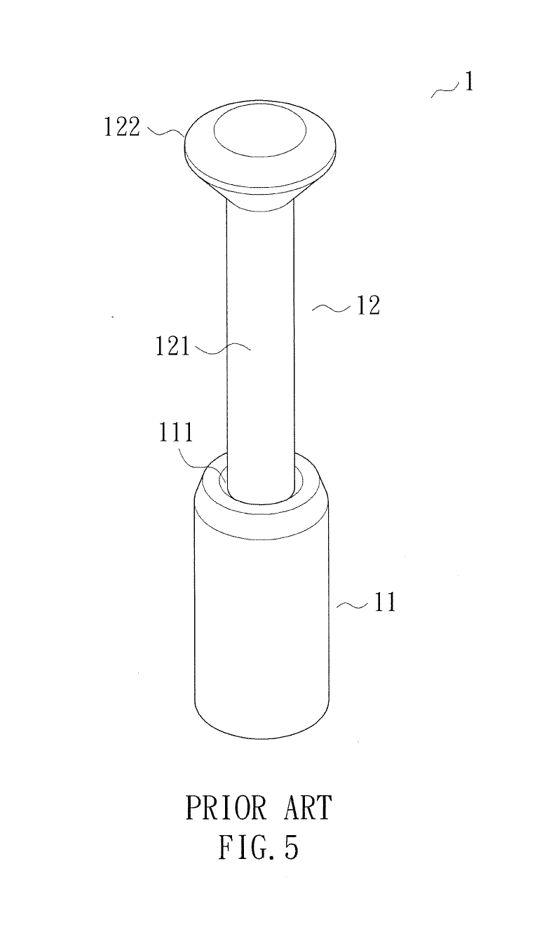

FIG. 6 shows a cross sectional view of the seal-lock of FIG. 5.

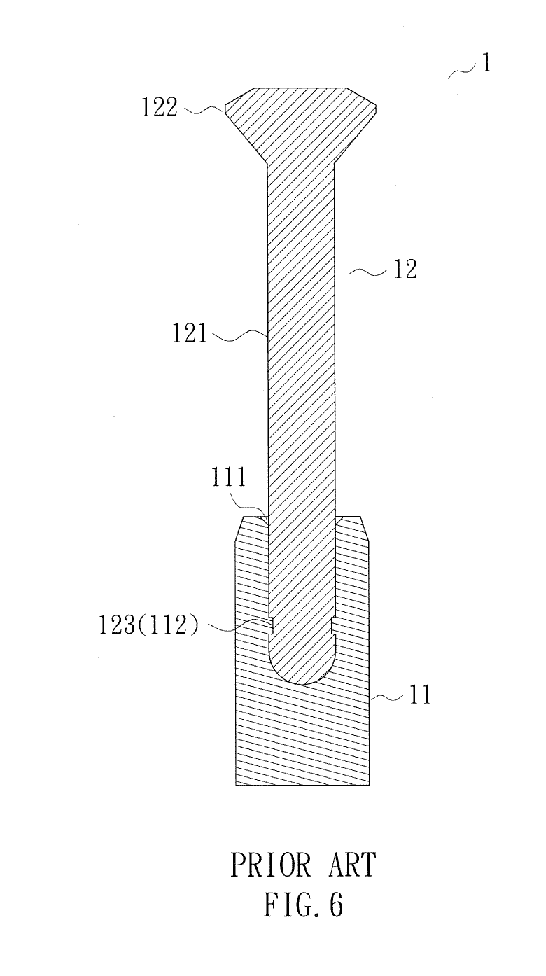

FIG. 7 shows a perspective view of the conventional seal-lock with protective covers.

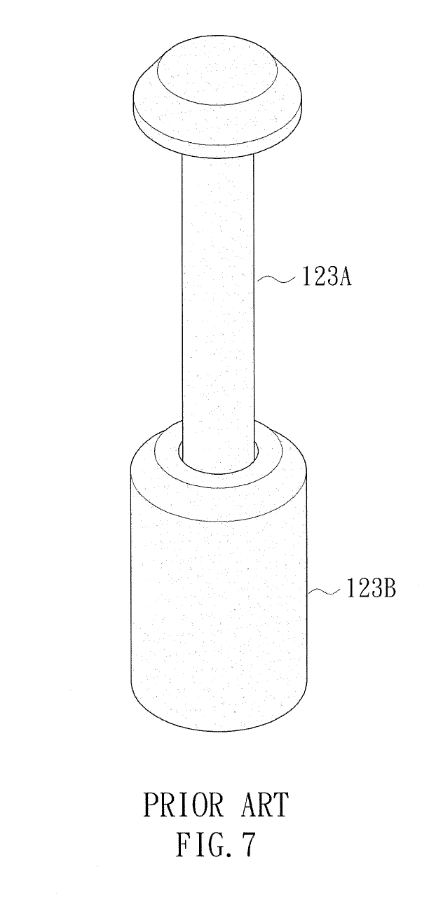

FIG. 8 shows a partial, perspective view of the seal-lock of FIG. 7, with the protective cover on a shank replaced with another protective cover.

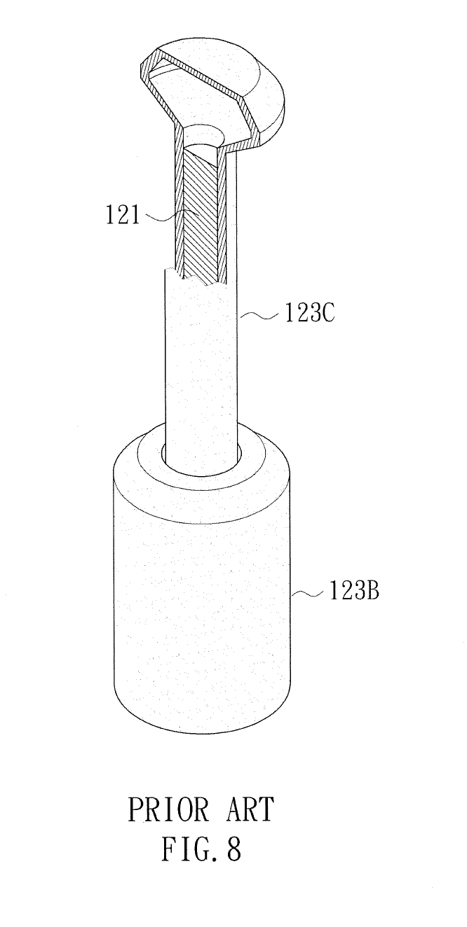

### DETAILED DESCRIPTION OF THE INVENTION

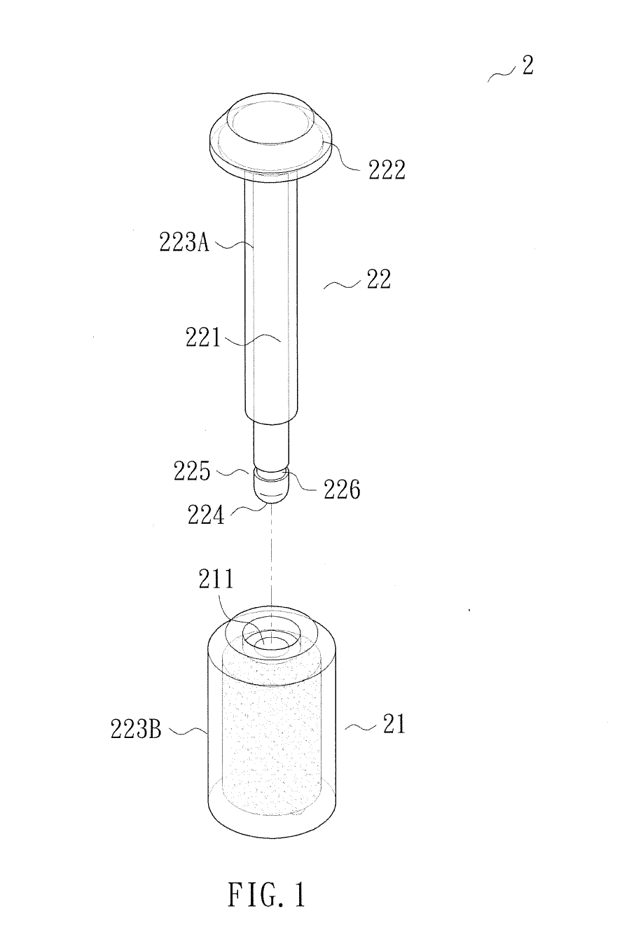

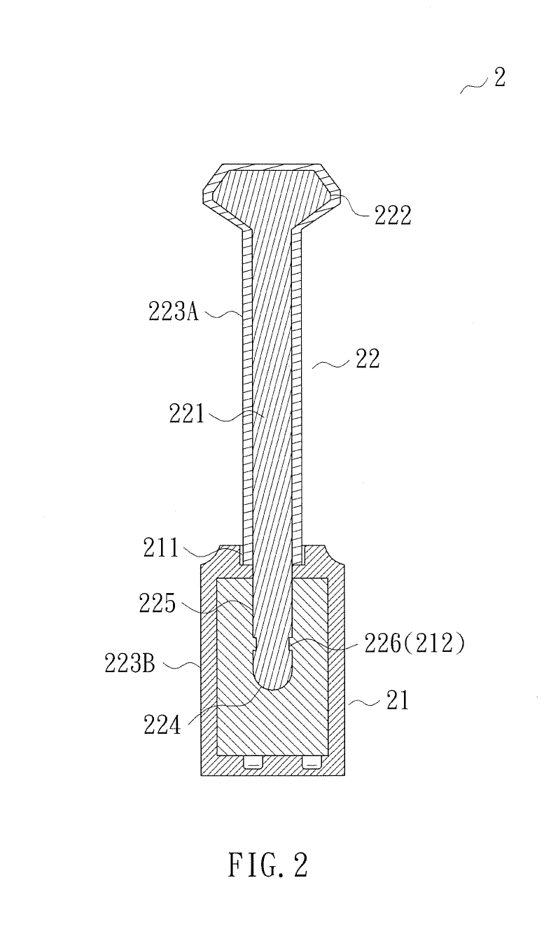

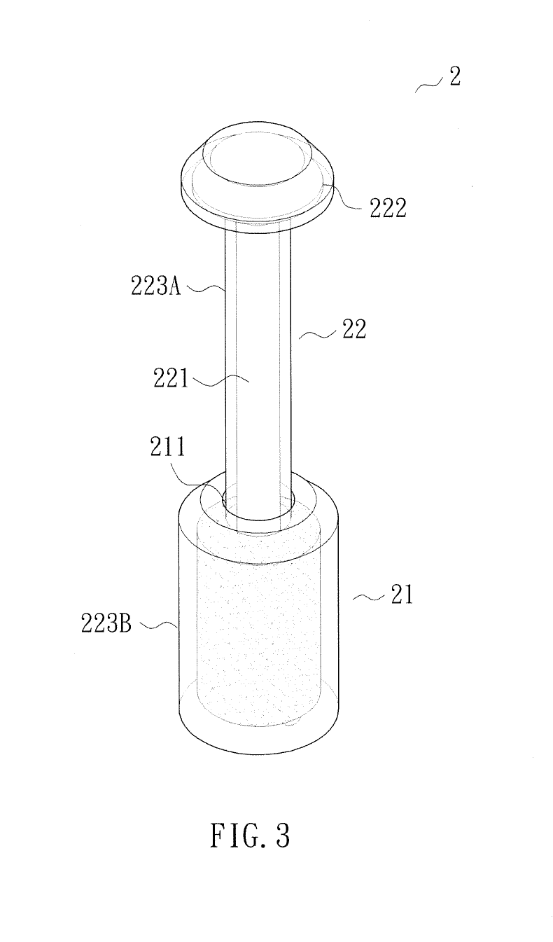

With reference to FIGS. 1-3, a seal-lock 2 with destruction-identifying structure according to the present invention includes a body 21 having an opening 211 in communication with an interior of the body 21. The seal-lock 2 further includes a bolt 221 having a shank 221. The shank 221 and the body 21 are so configured that coupling of the shank 221 and the body 21 is easy but disengagement of the shank 221 from the body 21 after coupling of the shank 221 and the body 21 is difficult. The bolt 22 includes a head 222 on a top end of the shank 221. The head 222 has a diameter larger than a diameter of the shank 221. A protective cover 223A is mounted around the head 222 and the shank 221 and is transparent. Optionally, a protective cover 223B can be mounted around the body 21. The protective cover 223B can be transparent or not transparent.

In an example of the easy-to-couple/difficult-to-disengage arrangement, the shank 221 includes a domed distal end 224 opposite to the head 222. The shank 221 further includes an insertion section 225 adjacent to the distal end 224. An annular groove 226 is formed in an outer periphery of the insertion section 225. The interior of the body 21 includes a flange 212. The flange 212 is pressed by the domed distal end 224 and the outer periphery of the insertion section 225 when the insertion section 225 is inserted into the interior of the body 21. The flange 212 extends into and is securely engaged in the annular groove 226 by the restitution of the flange 212 when the annular groove 226 is aligned with the flange 212.

When an intruder with an intention of stealing, switching, or destroying goods cuts a section of the shank 221 adjacent to the head 222, the protective cover 223A is also cut. In a case that the intruder replaces the cut protective cover 223A with a new transparent protective imitating the protective cover 223A, the destruction of the shank 221 can be easily seen through the new transparent protective cover. In another case that the intruder replaces the transparent protective cover 223A with a non-transparent one, the cargo owner can immediately know the destruction. In either case, the cargo owner can immediately know the theft, switching, or destruction of the goods. Immediate actions, such as reporting to the police, proceeding with an investigation, immediately checking the goods, or notifying the goods receiver, can be taken.

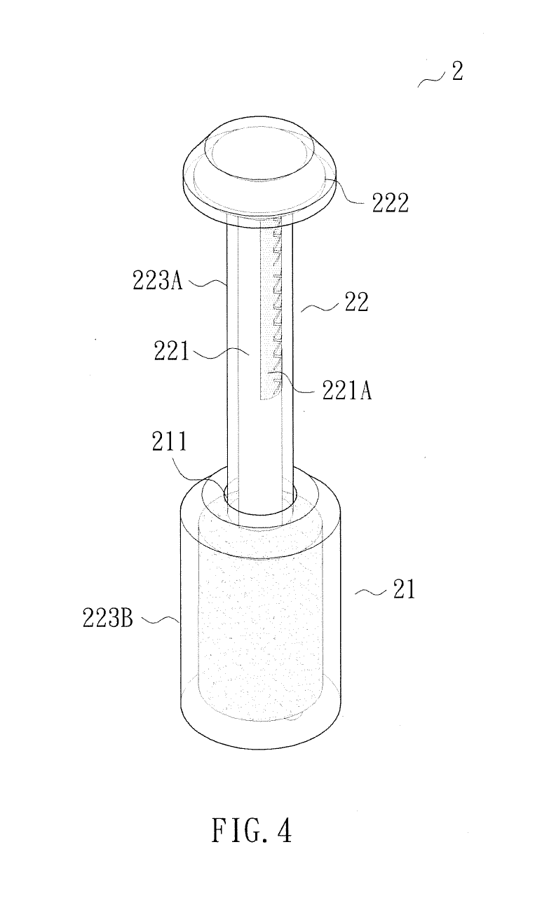

With reference to FIG. 4, the shank 221 can include a tag or pattern 221A formed on an outer periphery of the shank 221. The tag or pattern 221 A is selected from a group consisting of letters, figures, symbols, and numbers. The tag or pattern 221A is exposed out of the body 21 after the shank 221 is coupled with the body 21. If the head 222 is cut, the integrity of the tag or pattern 221A is damaged. This also assists in identification of destruction.

Although specific embodiments have been illustrated and described, numerous modifications and variations are still possible without departing from the essence of the invention. The scope of the invention is limited by the accompanying claims.

1. A seal-lock with destruction-identifying structure comprising:
a body including an interior and an opening in communication with the interior of the body; and
a bolt including a shank, with the shank and the body being so configured that coupling of the shank and the body is easy but disengagement of the shank from the body after coupling of the shank and the body is difficult, with the bolt including a head on a top end of the shank, with the head having a diameter larger than a diameter of the shank, with a transparent protective cover mounted around the head and the shank.

2. The seal-lock as claimed in claim 1, with the shank including a domed distal end opposite to the head, with the shank further including an insertion section adjacent to the domed distal end, with an annular groove formed in an outer periphery of the insertion section, with the interior of the body including a flange, with the flange being pressed by the domed distal end and the outer periphery of the insertion section when the insertion section is inserted into the interior of the body, with the flange extending into and securely engaged in the annular groove by restitution of the flange when the annular groove is aligned with the flange.

3. The seal-lock as claimed in claim 1, with the shank including a tag or pattern formed on an outer periphery of the shank, with the tag or pattern being selected from a group consisting of letters, figures, symbols, and numbers, with the tag or pattern exposed out of the body after the shank is coupled with the body.
